(19) United States
(12) Patent Application Publication
(10) Pub. No.: US 2002/0176056 A1
(43) Pub. Date: Nov. 28, 2002

(54) Projection display with two dichroic mirrors

(76) Inventor: Fu-Ming Chuang, Hsin-Chu Hsien (TW)

Correspondence Address: TROP PRUNER & HU, PC, 8554 KATY FREEWAY, SUITE 100, HOUSTON, TX, 77024, US

(21) Appl. No.: 09/928,637

(22) Filed: Aug. 13, 2001

Related U.S. Application Data
(63) Continuation-in-part of application No. 09/865,391, filed on May 25, 2001.

(51) Int. Cl. G03B 21/00

(52) U.S. Cl. 353/33

(57) ABSTRACT

In a projection display with two dichroic mirrors, input light is separated by a polarization beam splitter into a first color component, which is received by a first dichroic mirror and processed by a first light modulator, and second and third color components, which are received by a second dichroic mirror and processed by second and third light modulators, respectively.

### CROSS-REFERENCE TO RELATED APPLICATION

This application is a continuation-in-part (CIP) of co-pending U.S. patent application Ser. No. (Attorney Docket No. STIS:0055-US), filed on May 25, 2001.

### BACKGROUND OF THE INVENTION

1. Field of the Invention

The invention relates to a projection display with two dichroic mirrors, more particularly to a projection display that employs a polarization beam splitter and two dichroic mirrors so as to reduce the size and weight of the projection display.

2. Description of the Related Art

In co-pending U.S. patent application Ser. No. (Attorney Docket No. STIS:0055-US), filed on May 25, 2001, the applicant disclosed a three-prism projection display, wherein input light is separated via a polarization beam splitter prism into a first color component, which is received by a first dichroic beam splitter prism and processed by a first light modulator, and second and third color components, which are received by a second dichroic beam splitter prism and processed by second and third light modulators, respectively.

The projection display described in the aforesaid co-pending application employs three beam splitter prisms. As the prisms are formed from blocks of glass, there is residual stress remaining therein during the manufacture thereof. In use, as the prisms have to be secured in position, residual stress is also present. These residual stresses will result in a double refraction effect. Besides, the purity of the polarized color components passing through the prisms will be affected by the stresses. The longer the optical path of a color component through a prism, the less pure will be the polarization state of the color component, which aggravates the light leakage problem and in turn results in poor image quality. In addition, in order to eliminate stress, the projection display is relatively complicated in construction, which makes manufacture difficult and costly. Moreover, the prisms are relatively bulky.

### SUMMARY OF THE INVENTION

Therefore, the main object of the present invention is to provide a projection display with two dichroic mirrors, which is simple and inexpensive to manufacture, and which has reduced size and weight.

According to the present invention, a projection display is adapted to process an input light beam and to provide an output light beam to a projection lens. The input light beam includes first, second and third color components, each of which has a first polarization state. The projection display includes:

a first polarization state converter adapted to receive the input light beam and to convert the polarization state of the first color component to a second polarization state different from the first polarization state;

a polarization beam splitter disposed adjacent to the first polarization state converter so as to receive the input light beam therefrom, the polarization beam splitter separating the first color component from the second and third color components;

a first dichroic mirror disposed adjacent to the polarization beam splitter and permitting the first color component to pass therethrough;

a first light modulator disposed adjacent to the first dichroic mirror and receiving the first color component therefrom, the first light modulator modulating the first color component and changing the polarization state of the first color component back to the first polarization state when activated, the first light modulator reflecting the first color component back to the first dichroic mirror;

a second dichroic mirror disposed adjacent to the polarization beam splitter and receiving the second and third color components therefrom, the second dichroic mirror separating the second color component from the third color component;

a second light modulator disposed adjacent to the second dichroic mirror and receiving the second color component therefrom, the second light modulator modulating the second color component and changing the polarization state of the second color component to the second polarization state when activated, the second light modulator reflecting the second color component back to the second dichroic mirror; and

a third light modulator disposed adjacent to the second dichroic mirror and receiving the third color component therefrom, the third light modulator modulating the third color component and changing the polarization state of the third color component to the second polarization state when activated, the third light modulator reflecting the third color component back to the second dichroic mirror. The polarization beam splitter receives from the first dichroic mirror the first color component reflected by the first light modulator, further receives from the second dichroic mirror the second and third color components reflected by the second and third light modulators, and is adapted to direct the first, second and third color components received from the first and second dichroic mirrors to the projection lens.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of the first preferred embodiment of a projection display with two dichroic mirrors according to the invention in an activated state; and

FIG. 2 is a schematic view of the second preferred embodiment of a projection display with two dichroic mirrors according to the invention in an activated state.

### DETAILED DESCRIPTION OF THE PREFERRED EMBODIMENTS

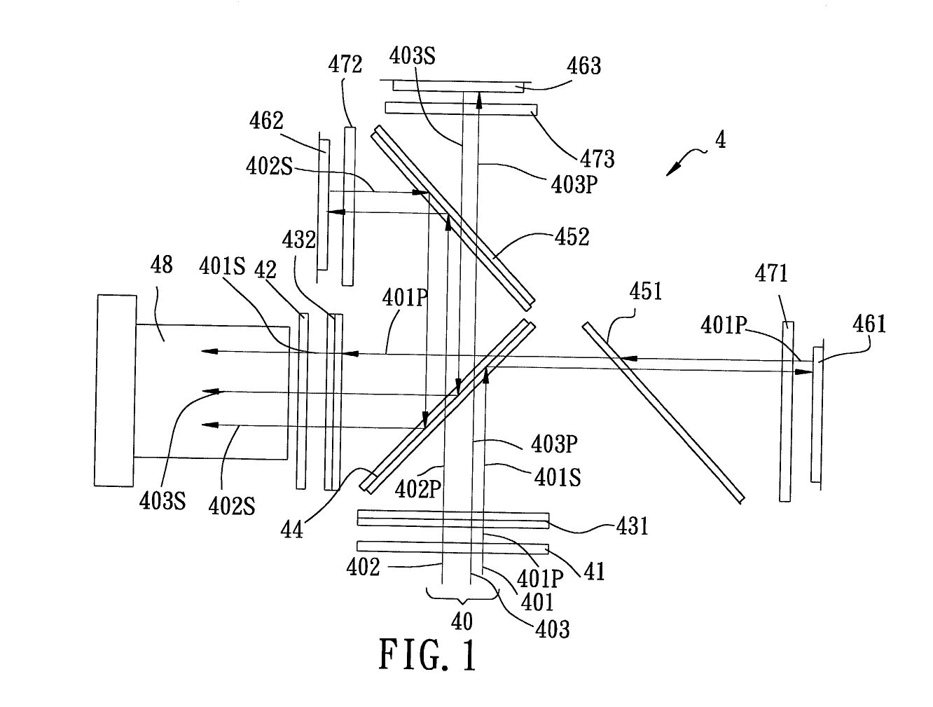

Referring to FIG. 1, the preferred embodiment of a projection display 4 with two dichroic mirrors according to the present invention is shown to include a first (P-polarization state) polarizer 41, a second (S-polarization state) polarizer 42, a first polarization state converter 431, a second polarization state converter 432, a polarization beam splitter 44, a first dichroic mirror 451, a second dichroic mirror 452, a first light modulator 461, a second light modulator 462, a third light modulator 463, and first, second and third optical path compensating plates 471, 472, 473. An input light beam 40 from an illuminating apparatus (not shown) is inputted from one side of the first polarizer 41 so that an output light beam can be provided to a projection lens 48. The input light beam 40 is generally white light that contains first, second and third color components 401, 402, 403, each of which has a first polarization state. In this embodiment, the first, second and third color components 401, 402, 403 are green, blue and red color components, respectively. The first, second and third color components 401, 402, 403 are processed by the first, second and third light modulators 461, 462, 463, respectively. Hereinafter, the present invention will be described as if the first, second and third light modulators 461, 462, 463 are in an activated state. In addition, for the sake of illustration, S-polarized first, second and third color components are respectively referred to as 401S, 402S, 403S, whereas the P-polarized first, second and third color components are respectively referred to as 401P, 402P, 403P. The first and second polarizers 41, 42 allow color components of different polarization states to pass therethrough, respectively. Light is a kind of electromagnetic wave that contains color components of varying polarization vectors. A polarizer permits only color components of a specific polarization state that is perpendicular to an optical path to pass therethrough, and absorbs the other color components. Therefore, the polarizer can be in the form of a grid that permits passage of light of a certain polarization state therethrough. In this embodiment, the first polarizer 41 permits only P-polarized color components to pass therethrough, and absorbs S-polarized color components. The second polarizer 42 permits only S-polarized color components to pass therethrough, and absorbs P-polarized color components. As shown in FIG. 1, the first polarizer 41 is disposed on one side of the first polarization state converter 431 opposite to the polarization beam splitter 44, and permits passage of the P-polarized first, second and third color components 401P, 402P, 403P to pass therethrough. The second polarizer 42 is disposed between the second polarization state converter 432 and the projection lens 48, and permits only S-polarized first, second and third color components 401S, 402S, 403S to pass therethrough so as to ensure the purity of the S-polarized color components 401S, 402S, 403S that reach the projection lens 48.

In this embodiment, the first and second polarization state converters 431, 432 are ColorSelect™ filter products from ColorLink Inc., and are disposed to receive the input light beam 40 and to convert the polarization state of a predetermined color component, for example, from the S-polarization state to the P-polarization state or vice versa. In this embodiment, the first polarization state converter 431 is disposed on the optical path of the input light beam 40 passing through the first polarizer 41 to convert the P-polarization state of the first color component 401 to the S-polarization state, while the P-polarization state of the second and third color components 402, 403 that also pass therethrough remains unaltered.

The second polarization state converter 432, which is disposed between the polarization beam splitter 44 and the second polarizer 42, receives the first, second and third color components 401, 402, 403 via the polarization beam splitter 44, and converts the P-polarized first color component 401P into S-polarized first color component 401S before the latter reaches the second polarizer 42.

In this embodiment, the polarization beam splitter 44 is formed as a planar glass sheet, specifically a laminate of two glass lens pieces having a beam splitting film plated therebetween, that is capable of reflecting perpendicularly the S-polarized color components while permitting P-polarized color components to pass therethrough. The polarization beam splitter 44 is disposed between the first and second polarization state converters 431, 432 at a +450 angle relative to an optical axis of the projection lens 48 so as to receive the input light beam 40 from the first polarization state converter 431. As shown in FIG. 1, the polarization beam splitter 44 is located above the first polarization state converter 431 and on the right side of the second polarization state converter 432. When the S-polarized first color component 401S and the P-polarized second and third color components 402P, 403P from the first polarization state converter 431 reach the polarization beam splitter 44, the S-polarized first color component 401S is reflected perpendicularly to the right, while the P-polarized second and third color components 402P, 403P pass upwardly through the polarization beam splitter 44, thereby separating the S-polarized first color component 401S from the P-polarized second and third color components 402P, 403P.

The first and second dichroic mirrors 451, 452 are both planar plates of glass, each of which is formed by a stack of laminates of different refractive indices. The material, thickness, and number of the laminates can be controlled to enable an incident light beam to pass therethrough or to be reflected thereby within a determined range of wavelengths such that color components of different wavelengths can be made to pass therethrough or to be reflected thereby. Besides, the first and second dichroic mirrors 451, 452 can be disposed at an inclined angle according to the path of the light beam. Certainly, during manufacture, each of the first and second dichroic mirrors 451, 452 may be formed as a planar glass sheet having one side coated with a beam splitting layer, or a planar laminate of two glass lens pieces bonded together and having a beam splitting film sandwiched therebetween. In this embodiment, both of the first and second dichroic mirrors 451, 452 are disposed at a −45° angle relative to the optical axis of the projection lens 48. The first dichroic mirror 451 is disposed on the right side of the polarization beam splitter 44 while the second dichroic mirror 452 is disposed above the polarization beam splitter 44 such that the S-polarized first color component 401S from the polarization beam splitter 44 reaches the first dichroic mirror 451 whereas the P-polarized second and third color components 402P, 403P from the polarization beam splitter 44 reach the second dichroic mirror 452. The first dichroic mirror 451 permits the S-polarized first color component 401S to pass rightward therethrough and reflects the other color components perpendicularly downward. The second dichroic mirror 452 permits the P-polarized third color component 403P to pass upwardly therethrough and reflects the P-polarized second color component 402P perpendicularly to the left, thereby separating the P-polarized second color component 402P from the P-polarized third color component 403P.

The first, second and third light modulators 461, 462, 463 are preferably reflective light valves. Upon receiving the first, second and third color components 401, 402, 403 and when activated, the first, second and third light modulators 461, 462, 463 modulate the first, second and third color components 401, 402, 403, respectively, and change the polarization states thereof for subsequent reflection in opposite directions. In FIG. 1, the first light modulator 461 is disposed adjacent to the first dichroic mirror 451 on the optical path of the first color component 401 so as receive the S-polarized first color component 401S from the first dichroic mirror 451. The first light modulator 461 modulates the S-polarized first color component 401S, changes the polarization state thereof back to the P-polarization state, and reflects the P-polarized first color component 401P in an opposite direction back to the first dichroic mirror 451.

The second light modulator 462 is disposed adjacent to the second dichroic mirror 452 on the optical path of the second color component 402 so as to receive the P-polarized second color component 402P from the second dichroic mirror 452. The second light modulator 462 modulates the P-polarized second color component 402P, changes the polarization state thereof back to the S-polarization state, and reflects the S-polarized second color component 402S in an opposite direction back to the second dichroic mirror 452.

The third light modulator 463 is disposed adjacent to the second dichroic mirror 452 on the optical path of the third color component 403 so as to receive the P-polarized third color component 403P therefrom. The third light modulator 463 modulates the P-polarized third color component 403P, changes the polarization state thereof back to the S-polarization state, and reflects the S-polarized third color component 403S in an opposite direction back to the second dichroic mirror 452.

The polarization beam splitter 44 receives from the first dichroic mirror 451 the P-polarized first color component 401P reflected by the first light modulator 461, further receives from the second dichroic mirror 452 the S-polarized second and third color components 402S, 403S reflected by the second and third light modulators 462, 463, and directs the same to the projection lens 48.

The first, second and third optical path compensating plates 471, 472, 473 are respectively disposed adjacent to the first, second and third light modulators 461, 462, 463 on the optical path of a respective color component. That is, the first optical path compensating plate 471 is disposed between the first dichroic mirror 451 and the first light modulator 461, whereas the second and third optical path compensating plates 472, 473 are disposed between the second dichroic mirror 452 and the respective one of the second and third light modulators 462, 463. The first, second and third optical path compensating plates 471, 472, 473 compensate the optical path of the respective one of the first, second and third color components 401, 402, 403 or any phase difference thereof so that the first, second and third color components 401, 402, 403, which travel along different optical paths after being split by the polarization beam splitter 44, have equal phase differences or uniform optical path lengths measured from the first polarization state converter 431 to the projection lens 48.

In use, when the first, second and third color components 401, 402, 403 are projected onto the first polarizer 41, the P-polarized first color component 401P is allowed to pass through the first polarizer 41, and is converted into the S-polarized first color component 401S upon passage through the first polarization state converter 431. The S-polarized first color component 401S is projected toward the polarization beam splitter 44, and is reflected thereby for successive passage through the first dichroic mirror 451 and the first optical path compensating plate 471 before reaching the first light modulator 461. The first light modulator 461 modulates the S-polarized first color component 401S, changes the polarization state thereof to the P-polarization state, and reflects the P-polarized first color component 401P in an opposite direction. The P-polarized first color component 401P passes successively through the first optical path compensating plate 471, the first dichroic mirror 451, and the polarization beam splitter 44 to reach the second polarization state converter 432. Upon passage through the second polarization state converter 432, the polarization state of the P-polarized first color component 401P is converted back to the S-polarization state. The S-polarized first color component 401S subsequently passes through the second polarizer 42 so as to have a purer polarization state prior to reaching the projection lens 48.

When the second color component 402 is projected onto the first polarizer 41, the P-polarized second color component 402P is allowed to pass through the first polarizer 41, the first polarization state converter 431, and the polarization beam splitter 44. When the P-polarized second color component 402P reaches the second dichroic mirror 452, it is reflected toward the left so as to pass through the second optical path compensating plate 472 and reach the second light modulator 462. The second light modulator 462 modulates the P-polarized second color component 402P, changes the polarization state thereof to the S25 polarization state, and reflects the S-polarized second color component 402S in an opposite direction for subsequent passage through the second optical path compensating plate 472 and so as to reach the second dichroic mirror 452. The second dichroic mirror 452 reflects the S-polarized second color component 402S toward the polarization beam splitter 44, which directs the S-polarized second color component 402S to pass successively through the second polarization state converter 432 and the second polarizer 42 before reaching the projection lens 48.

When the third color component 403 is projected onto the first polarizer 41, the P-polarized third color component 403P passes through the first polarizer 41 and the first polarization state converter 431, and further through the polarization beam splitter 44, the second dichroic mirror 452, and the third optical path compensating plate 473. When the P-polarized third color component 403P reaches the third light modulator 463, the third light modulator 463 changes the polarization state thereof to the S-polarization state, and reflects the S-polarized third color component 403S in an opposite direction for passage through the third optical path compensating plate 473 and the second dichroic mirror 452 and so as to reach the polarization beam splitter 44. The polarization beam splitter 44 directs the S-polarized third color component 403S to pass successively through the second polarization state converter 432 and the second polarizer 42 before reaching the projection lens 48.

In the present invention, since the polarization beam splitter 44 and the first and second dichroic mirrors 451, 452 are in the form of planar plates, the double refraction problem associated with the aforesaid three-prism projection display will not exist. As regards the problems of different optical path lengths and phase differences that may arise with the use of planar plates instead of prisms, the present invention employs optical path compensating plates to forestall any such problems. Certainly, if the planar plates have a small thickness and the optical path length and/or phase differences are insignificant, the optical path compensating plates can be dispensed with.

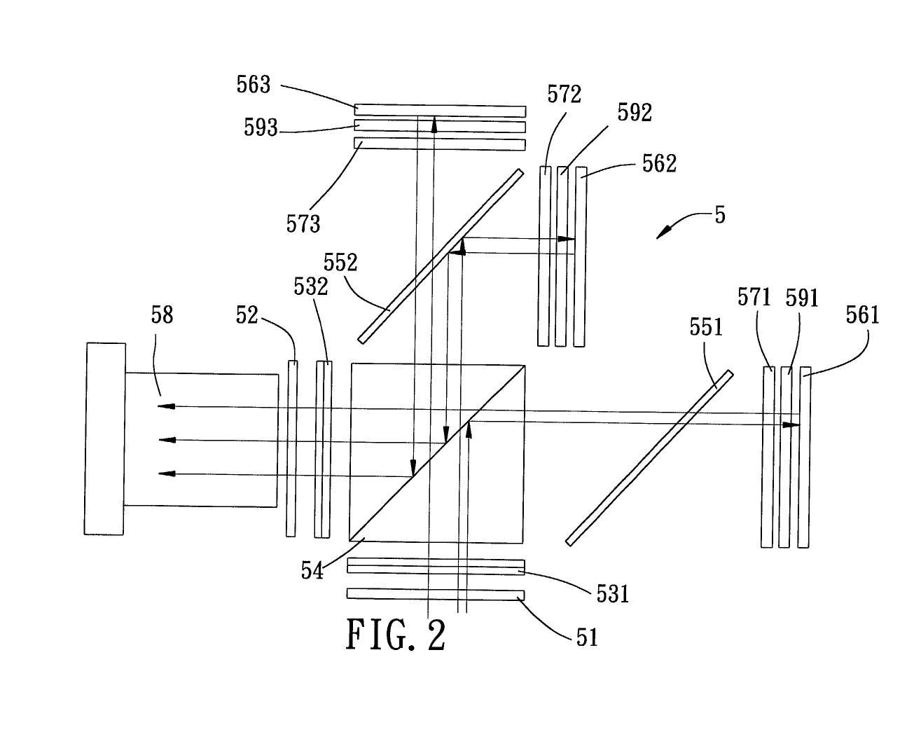

Referring to FIG. 2, the second preferred embodiment of a projection display 5 according to the present invention is substantially similar to the previous embodiment in construction, and is shown to include first and second polarizers 51, 52, first and second polarization state converters 531, 532, a polarization beam splitter 54, first and second dichroic mirrors 551, 552, first, second and third light modulators 561, 562, 563, and first, second and third optical path compensating plates 571, 572, 573. The difference between this embodiment and the previous embodiment resides in that the polarization beam splitter 54 is not formed as a planar plate but is constructed from two right-angled prisms that are bonded together to form an inclined beam splitting interface. Besides, the first and second dichroic mirrors 551, 552 are both disposed at a +45° angle relative to an optical axis of a projection lens 58, and the second optical path compensating plate 572 and the second light modulator 562 are disposed on the right side of the second dichroic mirror 552 to match the angle of a plated refractive film of the second dichroic mirror 552. In addition, this embodiment further includes first, second and third quarter-wavelength plates 591, 592, 593, each of which is disposed between a respective one of the first, second and third optical path compensating plates 571, 572, 573, and the adjacent one of the first, second and third light modulators 561, 562, 563, for improved contrast.

Certainly, the polarization beam splitter 54 of the second preferred embodiment can be in the form of a planar plate as in the first preferred embodiment, and quarter-wavelength plates can be included in the first preferred embodiment.

It is noted that the optical components, such as the polarization beam splitter and the dichroic mirrors, as used in the present invention may be in the form of a planar glass sheet or a film-plated planar plate. Moreover, in order to match the inclinedly-disposed planar plates, optical path compensating plates are provided to ensure uniform optical path lengths and phase differences of the color components. The planar plates, aside from being compact and light, are easy and inexpensive to manufacture. In use, the problem of double refraction can be eliminated, and the projected color components are pure to ensure a high quality image output.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A projection display adapted to process an input light beam and to provide an output light beam to a projection lens, the input light beam including first, second and third color components, each of which has a first polarization state, said projection display comprising:
a first polarization state converter adapted to receive the input light beam and to convert the polarization state of the first color component to a second polarization state different from the first polarization state;
a polarization beam splitter disposed adjacent to said first polarization state converter so as to receive the input light beam therefrom, said polarization beam splitter separating the first color component from the second and third color components;
a first dichroic mirror disposed adjacent to said polarization beam splitter and permitting the first color component to pass therethrough;
a first light modulator disposed adjacent to said first dichroic mirror and receiving the first color component therefrom, said first light modulator modulating the first color component and changing the polarization state of the first color component back to the first polarization state when activated, said first light modulator reflecting the first color component back to said first dichroic mirror;
a second dichroic mirror disposed adjacent to said polarization beam splitter and receiving the second and third color components therefrom, said second dichroic mirror separating the second color component from the third color component;
a second light modulator disposed adjacent to said second dichroic mirror and receiving the second color component therefrom, said second light modulator modulating the second color component and changing the polarization state of the second color component to the second polarization state when activated, said second light modulator reflecting the second color component back to said second dichroic mirror; and
a third light modulator disposed adjacent to said second dichroic mirror and receiving the third color component therefrom, said third light modulator modulating the third color component and changing the polarization state of the third color component to the second polarization state when activated, said third light modulator reflecting the third color component back to said second dichroic mirror;
said polarization beam splitter receiving from said first dichroic mirror the first color component reflected by said first light modulator, further receiving from said second dichroic mirror the second and third color components reflected by said second and third light modulators, and being adapted to direct the first, second and third color components received from said first and second dichroic mirrors to the projection lens.

2. The projection display as claimed in claim 1, further comprising a second polarization state converter adapted to be disposed between said polarization beam splitter and the projection lens, said second polarization state converter receiving the first, second and third color components to be directed by said polarization beam splitter to the projection lens, and converting the polarization state of the first color component to result in the output light beam, wherein the first, second and third color components of the output light beam have the second polarization state.

3. The projection display as claimed in claim 2, further comprising a polarizer adapted to be disposed between said second polarization state converter and the projection lens, said polarizer being adapted to absorb light that has the first polarization state and to permit light that has the second polarization state to pass therethrough.

4. The projection display as claimed in claim 1, further comprising first, second and third optical path compensating plates, each of which is disposed adjacent to a respective one of said first, second and third light modulators, thereby ensuring that the first, second and third color components have uniform optical path lengths measured from said first polarization state converter to the projection lens.

5. The projection display as claimed in claim 4, further comprising first, second and third quarter-wavelength plates, each of which is disposed between a respective one of said first, second and third optical path compensating plates, and the adjacent one of said first, second and third light modulators.

6. The projection display as claimed in claim 1, further comprising a polarizer disposed on one side of said first polarization state converter opposite to said polarization beam splitter, and adapted to absorb light that has the second polarization state and to permit light that has the first polarization state to pass therethrough.

7. The projection display as claimed in claim 1, wherein said polarization beam splitter is formed as a planar plate that is disposed at a 45° angle relative to an optical axis of the projection lens.

8. The projection display as claimed in claim 1, wherein said polarization beam splitter is constructed from two right-angled prisms that are bonded together to form an inclined beam splitting interface.
